(19) United States
(12) Patent Application Publication
(10) Pub. No.: US 2006/0121813 A1
(43) Pub. Date: Jun. 8, 2006

(54) Base material for automobile interior material and manufacturing method for the same

(76) Inventors: Masaki Kobayashi, Moriyama-shi (JP); Akira Utsumi, Moriyama-shi (JP)

Correspondence Address: BELL, BOYD & LLOYD, LLC, PO BOX 1135, CHICAGO, IL, 60690-1135, US

(21) Appl. No.: 11/274,242

(22) Filed: Nov. 14, 2005

(30) Foreign Application Priority Data
Nov. 15, 2004 (JP) P2004-329909
Apr. 12, 2005 (JP) P2005-114870

(51) Int. Cl. D04H 1/00; D04H 3/00; B32B 27/12; D04H 1/46

(52) U.S. Cl. 442/415; 442/394; 442/414; 442/338; 442/402; 442/352

(57) ABSTRACT

A base material for an automobile interior material and manufacturing method for same are provided. The base material for an automobile interior material is continuously accumulated in a direction orthogonal to a thickness direction in a state that two or more kinds of base-material constituting fibers including heat adhesive staple fibers are oriented in the thickness direction. The base material includes a fibrous layer formed by a fibrous web in which the base-material constituting fibers are mutually entangled, and a thermoplastic resin sheet layer laminated on at least one of principal surfaces of the fibrous layer.

### CROSS REFERENCE TO RELATED APPLICATIONS

The present invention claims priority to Japanese Patent Application Nos. 2004-329909 filed on Nov. 15, 2004 and 2005-114870 filed on Apr. 12, 2005, the entire contents of which are being incorporated herein by reference.

### BACKGROUND

The present invention relates to a base material for an automobile interior material and a method for manufacturing the same, and specifically relates to a base material for an automobile interior material such as a headliner material, a rear package tray material, a door trim material, a floor insulator material, a trunk trim material, a dash insulator material and the like and a method for manufacturing the same.

Conventionally, an automobile interior material is manufactured in such a manner that designed skin materials are laminated on a base material for the interior as a main base material, which is fabricated by heat forming so as to be in a shape corresponding to an applying portion. A plastic sheet, a plastic foam, a thermosetting resin felt, a cardboard, or a hardboard or a paperboard treated by adding wood flour or wastepaper to such material as a thermosetting resin material can be used as the base material for the automobile interior material.

These days, however, social demands such as resource saving and recycling arise, accordingly characteristics required for the interior material have been variously changed. Specifically, not only the conventional demand to provide sufficient rigidity, but also other demands such as weight saving for fuel consumption improvement of an automobile, heat resistance improvement for shape preserving characteristics (also referred to as shape preserving function) in a hot environment of about 100° C., vibration suppression improvement and recycling efficiency improvement are required to be responded.

As for an automobile interior material or a base material for an interior material with the characteristics in response to such demands, the following technologies are known, for instance.

First, Japanese Patent Application Laid-open No. 2000-229369 has disclosed a laminated body of nonwoven fabric used not only as automobile interior material but also as basic material for forming interior material by adhering skin materials made of fabrics such as a woven fabric, a knitted fabric or a nonwoven fabric thereon and lamination thereof. The laminated body of the nonwoven fabric in Japanese Patent Application Laid-open No. 2000-229369 includes a rigid layer formed by entangled nonwoven fabrics whose average strength of longitudinal tensile strength and lateral tensile strength is 150 N/50 mm width or more in a state of a simply entangled nonwoven fabric whose shape is maintained only by entanglement of fibers, and a high bulk layer formed by nonwoven fabrics whose apparent density is lower than the one in the rigid layer. It is assumed that adoption of such arrangement to the laminated body of the nonwoven fabric, weight saving as the interior material can be achieved while retaining sufficient rigidity by means of the rigid layer having a high level of fiber entanglement and the high bulk layer having a predetermined apparent density.

Moreover, Japanese Patent Application Laid-open No. 2003-247121 has disclosed a polyester heat adhesive fiber formed by a polymer in which a modified polybutylene terephthalate (polyester A) whose melting temperature is between 180° C. and 220° C. and a polyester B whose melting temperature is equal to or less than 180° C. are melt-blended within the range of blend ratio by weight: A/B=10/90 to 80/20. According to Japanese Patent Application Laid-open No. 2003-247121, it is assumed that this technology enables to obtain heat resistance that is not able to be realized as a cushion material used for an automobile headliner material which is exposed to such an environment as 90° C. to 100° C., such heat resistance being unable to be realized in a conventional manner.

Furthermore, Japanese Patent Application Laid-open No. Hei 9-226480 has disclosed a sheet-like fiber structure in which a main fiber (A) made of thermoplastic synthetic resin, a binder fiber (B) and a fibrillar fiber (C) are oriented substantially orthogonal to a sheet surface and fusion bonded by heat with each other. In the fiber structure, as shown in FIG. 5, constituting fibers 91 are processed by a carding machine whereby a fibrous web 90 is formed in parallel to the sheet surface. After that, the fibrous web 90 is folded in a wave shape, so that the constituting fiber 91 can be oriented substantially orthogonal to the sheet surface. It is assumed that such arrangement of the structure can moderate fatigue deformation due to applied load as compared to the conventional structure whose fiber orientation is in parallel to the sheet surface. Therefore, it is also assumed that, owing to such a function so as to depress the density increase of the structure even in the case where the surface load is applied, a predetermined density and a dynamic spring ratio are retained satisfactorily, thereby it is possible to achieve an excellent weight saving and vibration suppression efficiency.

Besides, there is also a case where the weight saving is intended through eliminating various components under such circumstances that fuel economy improvement is demanded by reducing a vehicle weight. For instance, in a case of a headliner material that is formed by attaching a skin material to a base material for the interior material, an annular attachment is conventionally installed on the basic material for the interior material and the attachment is inserted through a wire, whereby the basic material for the interior material is installed in a vehicle cabin. For the weight saving, however, there is known such a method that an attachment is abolished and installation state is maintained by the rigidity of the base material for the interior material itself.

### SUMMARY

The inventors of the present invention, in view of the foregoing related background, have paid attention especially to the rigidity and shape preserving characteristics in a high temperature environment among characteristics required for a base material for an automobile interior material, and have studied in various ways. In particular, as taught in Japanese Patent Application Laid-open No. Hei 9-226480, such a structure that a fibrous web is folded in a wave shape to orient fibers substantially orthogonal to a sheet surface has been studied. As a result, it was revealed that the structure disclosed in Japanese Patent Application Laid-open No. Hei 9-226480, when a fibrous web 90 was folded to mate the surfaces with each other, was provided with interfaces 92 as shown in FIG. 5 in a thickness direction of the structure, and thereby, the structure could not demonstrate a satisfactory shape preserving characteristics in a high temperature environment, if they were simply adhered by heating.

Therefore, in view of the above problems in the conventional technologies together with knowledge by the examinations, the present invention has been made, for example, to provide a base material for an automobile interior material which is excellent in rigidity and shape preserving characteristics in a high temperature environment.

A base material for an automobile interior material of the present invention includes: a fibrous layer including a fibrous web in which two or more kinds of base-material constituting fibers including a heat adhesive staple fiber are continuously accumulated in a direction orthogonal to a thickness direction of the fibrous web and mutually entangled in a state that the base-material constituting fibers are oriented in the thickness direction; and a thermoplastic resin sheet layer laminated on at least one of principal surfaces of the fibrous layer.

It is also preferable that a base material for an automobile interior material of the present invention includes: a fibrous layer in which a fibrous web is processed with needle punching after two or more kinds of base-material constituting fibers including a heat adhesive staple fiber are continuously accumulated in a direction orthogonal to a thickness direction of the fibrous web in a state that the base-material constituting fibers are oriented in the thickness direction by an air lay process; and a thermoplastic resin sheet layer laminated on at least one of principal surfaces of the fibrous layer.

According to an embodiment the present invention, a base material for an automobile interior material is continuously accumulated in a direction orthogonal to a thickness direction in a state that base-material constituting fibers are oriented in the thickness direction. Therefore, the base-material constituting fibers can be oriented in the thickness direction without folding of a fibrous web. In addition, an interface that is generated when the fibrous web is folded can be virtually prevented since the fibrous web is not folded, according to the present invention. Further, since the base-material constituting fibers oriented in the thickness direction of the fibrous web are mutually entangled, the base material for the automobile interior material has excellent rigidity and shape preserving characteristics in a high temperature environment.

Moreover, in the base material for an automobile interior material, a softening point of the heat adhesive staple fiber may be 90° C. or more. Owing to such heat adhesive staple fiber, shape preserving characteristics in a high temperature environment is further improved.

Moreover, in the base material for an automobile interior material, the fibrous web may include the heat adhesive staple fiber and a crimped hollow staple fiber as the base-material constituting fibers. When the crimped hollow staple fiber is included as the base-material constituting fibers, weight saving of a base material for the interior material becomes possible. Moreover, since crimps are developed by heating in the state that the hollow staple fibers having crimpable potential, which are fibers in a raw material state of the crimped hollow staple fiber, are oriented in a thickness direction of a fibrous web, the fiber orientation in a fibrous layer of the base material for the interior material remains preferable after heating even if the fibrous web is pressurized in the thickness direction.

Moreover, in the base material for an automobile interior material, the thermoplastic resin sheet layer may be a spunbonded nonwoven fabric including two kinds of filaments, and a difference of melting point between the filaments is 30° C. or more. Owing to such spunbonded nonwoven fabric, molding efficiency is improved as well as improvements in rigidity and shape preserving characteristics when used.

Moreover, in the base material for an automobile interior material, each of base-material constituting fibers may be made of polyester resin. When base-material constituting fibers is made of polyester resin, recycling performance will be improved.

The present invention will be described not only as a base material for an automobile interior material, but also as a manufacturing method of a base material for an automobile interior material.

A manufacturing method of a base material for an automobile interior material of the present invention includes: forming a fibrous web by continuously accumulating two or more kinds of base-material constituting fibers including a heat adhesive staple fiber in a direction orthogonal to a thickness direction of the fibrous web in a state that the base-material constituting fibers are oriented in the thickness direction; mutually entangling the base-material constituting fibers of the fibrous web; and adhering the heat adhesive staple fiber to the other base-material constituting fiber by heating the fibrous web in order to form a fibrous layer.

Alternatively, a manufacturing method of a base material for an automobile interior material of the present invention includes: forming a fibrous web by continuously accumulating two or more kinds of base-material constituting fibers including a heat adhesive staple fiber in a direction orthogonal to a thickness direction of the fibrous web in a state that the base-material constituting fibers are oriented in the thickness direction by an air lay process; entangling the fibrous web by needle punching process; and adhering the heat adhesive staple fiber to the other base-material constituting fiber by heating the fibrous web in order to form a fibrous layer.

By manufacturing a base material for an automobile interior material with the above steps, a base material for the automobile interior material having the above-mentioned structure can be provided.

Moreover, in the manufacturing method of the present invention, the fibrous web may include the heat adhesive staple fiber and a hollow staple fiber having crimpable potential as the base-material constituting fibers. Since the hollow staple fibers having crimpable potential are included as the base-material constituting fibers, weight saving of a base material for the interior material becomes possible. Moreover, since crimps are developed by heating in the state that the hollow staple fibers having crimpable potential, which are fibers in a raw material state of the crimped hollow staple fiber, are oriented in a thickness direction of a fibrous web, the fiber orientation in a fibrous layer of the base material for the interior material remains preferable after the heat adhering step, even when the fibrous web is pressurized in the thickness direction.

Moreover, the manufacturing method of the present invention may further include laminating a thermoplastic resin sheet layer on at least one of principal surfaces of the fibrous layer. By laminating the thermoplastic resin sheet layer, a base material for an automobile interior material will be further improved in rigidity and shape preserving characteristics.

Additional features and advantages are described herein, and will be apparent from, the following Detailed Description and the figures.

### BRIEF DESCRIPTION OF THE FIGURES

FIG. 1 is a cross-sectional schematic drawing showing an aspect of a fibrous web in a base material for the interior according to an embodiment of the present invention.

FIG. 2 is a view showing schematically a principal part of a carding machine for forming a fibrous web in a base material for the interior according to an embodiment of the present invention.

FIG. 3 is a cross-sectional view showing a base material for the interior according to one embodiment of the present invention.

FIG. 4 is a cross-sectional view showing a base material for the interior according to another embodiment of the present invention.

FIG. 5 is a view explaining a fibrous web forming in the conventional art.

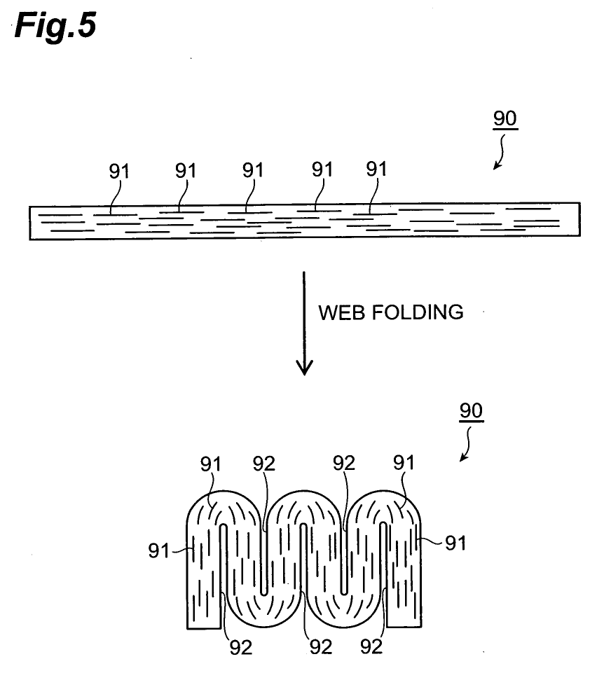

### DETAILED DESCRIPTION

Hereinafter, preferred embodiments of the present invention will be described with reference to the accompanying drawings.

A base material for an automobile interior material according to an embodiment of the present invention includes a fibrous layer composed of a fibrous web formed by two or more kinds of base-material constituting fibers including a heat adhesive staple fiber, and a thermoplastic resin sheet adhered to and laminated on at least one of principal surfaces of the fibrous layer.

Note that “a base-material constituting fiber” is a fiber component that forms a fibrous layer or a fibrous web.

The base material for the automobile interior material is used for an automobile interior material such as a headliner material, a rear-package-tray material, a door trim material, a floor insulator material, a trunk trim material and a dash insulator material. Moreover, when the base material is used as the automobile interior material, the base material may form a laminated structure after a designed skin material is adhered thereto.

Next, the structure of the basic material for the automobile interior material will be explained in detail.

First, a base-material constituting fiber used for forming a fibrous web will be described.

A base-material constituting fiber can be processed by a carding machine that is capable of orienting a fiber in a thickness direction of a fibrous web, and a preferable length of the fiber is between 10 mm and 80 mm. In a case the length of the base-material constituting fiber is less than 10 mm, the carding capability is limited. Therefore, it becomes difficult to orient the fiber in the thickness direction. In contrast, in a case the length of the base-material constituting fiber is more than 80 mm, since unevenness is easily generated in the density of the fiber that is oriented in the thickness direction, it becomes difficult to equalize the density of the formed fibrous web.

Moreover, the basic-material constituting fiber includes at least a heat adhesive staple fiber and adopts two or more kinds of fibers. This is because, if the base material is formed only by the heat adhesive staple fiber, shape preserving characteristics (also refer to shape preserving function) in a high temperature environment of the inside of a vehicle, assumed to be for instance about 90° C. to 100° C., become insufficient. In the view of this point, it is preferable that softening point of the heat adhesive staple fiber is 90° C. or more.

Furthermore, in order to maintain the fiber morphology even at a heat adhering temperature, it is preferable that the heat adhesive staple fiber is a composite fiber in which a resin component (A) that softens at the heat adhering temperature and a resin component (B) whose softening point is higher than the one of the resin component (A) are blended. Such composite fiber includes, for example, a side-by-side type, a sea-island type, a sheath-core type and the like. As for the resin component whose softening point is 90° C. or more used for such composite fiber, for instance, a polyethylene terephthalate copolymerizing an isophthalic acid component as disclosed in aforementioned Japanese Patent Application Laid-open No. 2003-247121, or a polypropylene resin, a polybutylene terephthalate resin, a polyethylene resin, a polyamide resin or the like as disclosed in Japanese Patent Application Laid-open No. Sho 58-41912 can be optionally and suitably selected.

Herein, the heat adhering temperature is a temperature condition designed for a manufacturing process of a base material for an automobile interior material, especially herein it means such a temperature condition that a heat adhesive staple fiber is softened and the basic material for the interior material is formed so as to preserve the shape thereof even after cooling. On the other hand, herein the softening point is a temperature at which a fiber component of the basic material for the interior material can be deformed plastically, and the formed shape can be preserved even after cooling. Consequently, the softening point is specified in accordance with a material, in principle. Note that crystallization of the fiber component of the heat adhesive staple fiber advances generally after the adhering process is carried out, and thereby the heat adhering temperature after forming can be equal to or lower than the softening point. Moreover, the softening point of the fiber as a raw material and the softening point of the fiber after forming may be slightly different depending on the heating history.

Further, the base-material constituting fiber is, taking recycling performance into consideration, preferred to be composed as polyester resin such as a polyethylene terephthalate resin or polybutylene terephthalate resin. In this case, as for a polyester resin component corresponding to the aforementioned resin component (B) having high softening point, the one with softening point of approximately 220° C. is used.

The base-material constituting fiber combined with the heat adhesive staple fiber may include, as long as the shape of the fiber is maintained even at the heat adhering temperature, the polyester resin, an organic fiber made of a synthetic resin such as a polypropylene resin, a polyethylene resin, a polyamide resin, which are similar to the heat adhesive staple fiber, or even an inorganic fiber. As for such inorganic fibers, a glass fiber, a silicon carbide fiber, a silicon nitride fiber, an alumina fiber or a mineral fiber as typified by a basalt fiber or the like can be used, which can improve the rigidity of a fibrous layer due to the high rigidity of a single fiber in such inorganic fibers.

Furthermore, in forming a fibrous web in combination with the heat adhesive staple fibers, it is preferred to include a hollow staple fiber having crimpable potential as a base-material constituting fiber. Here, the hollow staple fiber having crimpable potential means a hollow fiber whose crimps are developed or increased by heating in a heat adhering step to form a fibrous layer in which the fibrous web is heated to adhere the heat adhesive staple fiber to other base-material constituting fibers in a production process of the base material for the interior material. Therefore, the “hollow staple fiber having crimpable potential” can be simply called as a “crimpable hollow staple fiber”. In addition, the hollow fiber, the crimps of which are developed or increased by the heating is called here as a crimped hollow staple fiber.

In a preferred embodiment of the hollow staple fiber having crimpable potential, for instance, a side-by-side type of staple fiber is included, in which two kinds of polyester with different intrinsic viscosity are used, the section thereof being a circular shape, an elliptic shape, an oblong shape or a polygonal shape having a hollow degree of 5% to 50%, and coil-like crimp or spiral crimp is developed by heating. In such hollow staple fibers having crimpable potential, the number of crimps before the heating is approximately 10 crimps to 20 crimps per inch, and the number of crimps after the heating increases to 50 crimps or more per inch.

Weight saving, enhancement of shape preserving characteristics and securement of the rigidity in a base material for the interior material become possible by use of such hollow staple fiber having crimpable potential. Moreover, since crimps are developed by heating in the state that the hollow staple fibers having crimpable potential are oriented in a thickness direction of a fibrous web, the fiber orientation in a fibrous layer of the base material for the interior material is not disturbed owing to the heat adhering step, even when the fibrous web is pressurized in the thickness direction, for instance, when a skin material is attached to the base material for the interior material. In addition, although the hollow staple fiber having crimpable potential is contracted by heating in a heat adhering step as described later, a size change by the contraction virtually affects only in the thickness direction. Therefore, a surface density of the fibrous layer is equalized and the reproducibility thereof is excellent.

As described so far, the base-material constituting fiber used for forming the fiber web is composed of two or more kinds of fibers including the heat adhesive staple fiber. A preferable compound weight ratio between the heat adhesive staple fiber and the other base-material constituting fibers is to be: (heat adhesive staple fiber)/(other base-material constituting fibers)=20/80 to 90/10. When the heat adhesive staple fiber is included less than the preferable ratio, the density of adhering points of fibers is decreased, whereby the rigidity and the shape preserving characteristics are deteriorated. In contrast, when the heat adhesive staple fiber is included more than the preferable ratio, in other words the heat adhesive staple fiber is excessively compounded, the rigidity and the shape preserving characteristics are deteriorated in the event of a temperature change from a room temperature to a high temperature environment.

Next, a fibrous web using the base-material constituting fiber and a fibrous layer formed by the fibrous web will be described.

A fibrous web in an embodiment of the present invention is formed by continuously accumulating base-material constituting fibers in a direction orthogonal to a thickness direction in the state where the base-material constituting fibers is oriented in the thickness direction of the fibrous web. In addition, when the fibrous layer is formed, the base-material constituting fibers of the fibrous web are mutually entangled.

Herein, “a state where the base-material constituting fibers are oriented in the thickness direction of the fibrous web” does not mean that all the fibers are always oriented in the thickness direction of the fibrous web, either the fibers are oriented in a direction orthogonal to a surface in the state of the fibrous layer as well. The state where the fibers are oriented in the thickness direction of the fibrous web in comparatively uniform manner is included.

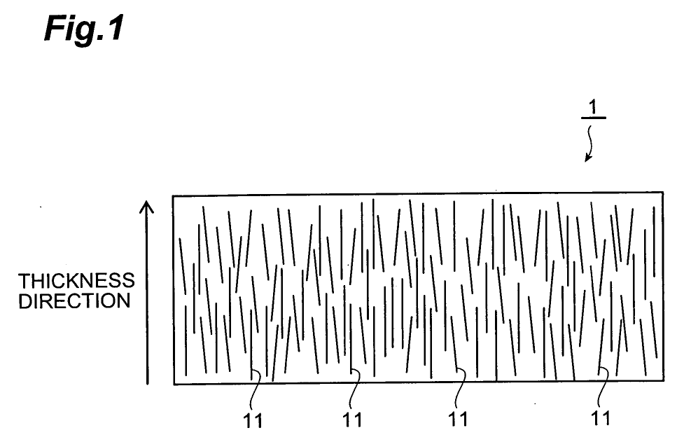

Moreover, “base-material constituting fibers are continuously accumulated in a direction orthogonal to a thickness direction in a state where the base-material constituting fibers are oriented in the thickness direction” includes that fibers 100 oriented in a thickness direction of a fibrous web 1 in comparatively uniform manner are accumulated in a direction orthogonal to the thickness direction as shown in a cross sectional schematic diagram of FIG. 1. Since such an embodiment is implemented, it is not needed to fold the fibrous web so that the base-material constituting fibers is oriented in a direction orthogonal to a principal surface like the fibrous web described in Japanese Patent Application Laid-open No. Hei 9-226480. As a result, an interface generated when the fibrous web is folded, is virtually eliminated.

Note that “A fibrous web in which base-material constituting fibers are accumulated in a direction orthogonal to a thickness direction of the fibrous web in a state where the base-material constituting fibers are oriented in the thickness direction of the fibrous web” can be formed by an air lay process (described in detail later).

Further, “the fibrous web in which the base-material constituting fibers are mutually entangled” can be obtained by applying a needle punching process (described in detail later) to the fibrous web. Note that, when the needle punching process is applied to the folded fibrous web described in Japanese Patent Application Laid-open No. Hei 9-226480, there is a tendency that folded state of the fibrous web is broken by the needle punching process, and the fiber is oriented in a direction orthogonal to the thickness direction of the fibrous web (in other words, the fiber is oriented in parallel to a principal surface of the fibrous web). The tendency becomes marked when a thick web layer is used to produce a thin fibrous layer after folded. In contrast, according to the embodiment, since in the fibrous web subject to the needle punch process, the base-material constituting fibers are oriented in the thickness direction of the fibrous web, there is less tendency that the fiber is oriented in the direction orthogonal to the thickness direction of the fibrous web by the needle punching process.

A heat adhering step as described later is applied to the above-mentioned fibrous web to obtain the fibrous layer. The fibrous layer has a high rigidity of bending in a plane direction throughout the principal surface, and also the fiber orientation of base-material constituting fibers becomes firm by the heat adhering step, enabling to obtain a fibrous layer with excellent performance of shape preserving characteristics in a high temperature environment.

A surface density of a fibrous layer can be variously designed in accordance with the desired rigidity and shape preserving characteristics. However, a preferable surface density is 200 g/m² or more in view of satisfying the rigidity and the shape preserving characteristics. From a viewpoint of weight saving of an automobile, the preferable surface density is 900 g/m² or less (the surface density equal to or less than 800 g/m² is more preferable). In addition, preferable thickness is, from the similar view point, between 3 mm and 15 mm.

Next, a thermoplastic resin sheet layer adhered to a fibrous layer will be explained.

As described above, a thermoplastic resin sheet layer is adhered to one or both of principal surfaces of a fibrous layer, so that a base material for an automobile interior material in the embodiment is formed to have a laminated structure. In addition, it is preferable that fibers contained in the thermoplastic resin sheet layer are oriented in a direction orthogonal to a thickness direction of the sheet layer in contrast to base-material constituting fibers of a fibrous web that forms the fibrous layer. The layers with different fiber orientation each other are thus adhered and laminated, resulting in the fiber orientation of the fibrous layer and the fiber orientation of the thermoplastic resin sheet layer become substantially vertical with each other, thereby enabling to improve the rigidity.

As for the thermoplastic resin sheet layer, the one whose dimension variation is small under an ordinary temperature of equal to or lower than 40° C. in a daily life and even the high temperature environment mentioned above, and the lowest softening point of constituting resin component is equal to or more than 90° C., can be optionally and preferably selected. More specifically, a filament nonwoven fabric as typified by a spunbonded nonwoven fabric, a spunlace nonwoven fabric, a staple nonwoven fabric such as a needle punched nonwoven fabric, a mesh, a film or the like can be used.

Especially, when the filament nonwoven fabric is adopted as the thermoplastic resin sheet layer, from a viewpoint of improving molding efficiency, the spunbonded nonwoven fabric formed by two or more kinds of filaments is preferred to be adopted. At this time, a difference of melting point between the two filaments is to be 30° C. or more. A preferable weight ratio of each fabric constituting resin in such two kinds of filaments is: (filament with a low melting point)/(filament with a high melting point)=5/95 to 95/5. More preferably, the weight ratio is to be: (filament with a low melting point)/(filament with a hot melting point)=5/95 to 50/50. It becomes difficult to satisfy the rigidity and the shape preserving characteristics if the value is out of the range of the preferable value. Besides, the length of the filament that forms the filament nonwoven fabric is not particularly limited as long as the filament is longer than a base-material constituting fiber (90 mm or more, for example).

Moreover, a preferable surface density of the thermoplastic resin sheet layer is 30 g/m² or more, in view of satisfying the rigidity and the shape preserving characteristics. From a viewpoint of a weight saving of an automobile, the surface density equal to or less than 200 g/m² is preferable. Further, preferable thickness of the resin sheet layer is, from the similar view point, between 0.1 mm and 2.0 mm.

Next, a manufacturing method of a base material for an automobile interior material according to an embodiment of the present invention will be explained.

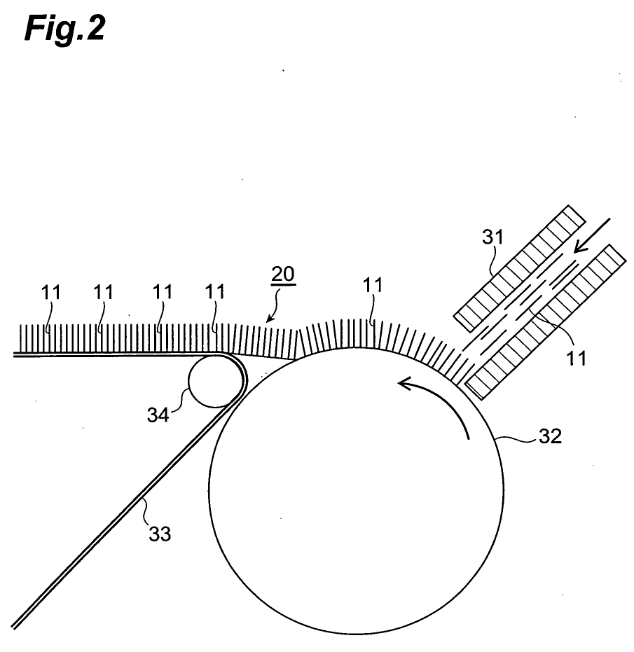

First, a web forming step that forms a fibrous web will be described with reference to FIG. 2.

As mentioned above, a fibrous web in a base material for the interior material in the present embodiment is continuously accumulated in a direction orthogonal to a thickness direction in a state where base-material constituting fibers are oriented in the thickness direction. Therefore, the fibrous web does not need to be folded so that the base-material constituting fibers are oriented in a direction orthogonal to a principal surface like the fibrous web as described in Japanese Patent Application Laid-open No. Hei 9-226480.

A carding machine using an air lay process can be used in order to form such fibrous web. FIG. 2 is a view showing schematically a principal part of the carding machine.

First, after two or more kinds of base-material constituting fibers 11 are equally blended in the carding machine, the fibers are opened. The opened base-material constituting fibers 11 are pulled and mostly aligned by airflow, and as shown in FIG. 2, collided in a direction orthogonal to a peripheral face of a cylindrical suction drum 32 with a meshed surface thereof by the airflow to be converged to form a fiber group 20. At this time, the base-material constituting fibers 11 are aspirated at a part where the base-material constituting fibers 11 are received around the peripheral face of the suction drum 32. After that, the converged fiber group 20 is transported by a conveyer provided with a belt 33 and a roller 34, whereby a fibrous web 1 which is continuously accumulated in a direction orthogonal to a thickness direction in a state where the base-material constituting fibers 11 are oriented in the thickness direction can be obtained.

A web forming apparatus including a carding machine using an air lay process, which is suitable for the web forming step, for instance, includes; “V21/R−K12” or “V21/K12” made by FEHRER, or “RANDO-WEBBER” (registered trademark) made by RANDO.

After the web forming step, an entangling step that entangles base-material constituting fibers of a fibrous web is performed. The entangling step may be performed on one side only of the fibrous web. However, the step is preferred to be performed on both sides unless the fiber orientation of the base-material constituting fibers is disturbed. Desirable shape preserving characteristics or rigidity as a base material for the interior material can be obtained while the fiber orientation of the base-material constituting fibers is maintained if the entangling step is performed on the both sides.

The entangling step can be performed in a needle punching process by a well-known needle punching machine. A punch density, a depth of a needle, a shape of a needle and the like in the needle punching process are optionally and preferably designed.

A heat adhering step is performed on the fibrous web in which the base-material constituting fibers are entangled in the entangling step. In the heat adhering step, the fiber is heated by well-known methods such as a heated air circulating furnace capable of heating under no pressure applied or a heating roll capable of pressurizing at a temperature in accordance with heat characteristic of a heat adhesive staple fiber, and the heat adhesive staple fiber is adhered to other base-material constituting fibers to obtain a fibrous layer.

Next, thermoplastic resin sheet layers are adhered and laminated on the fibrous layer obtained through web forming step, entangling step and heat adhering step as a laminating process, by means of interposing an adhesive layer or application of adhesive.

Structure of the base material for the interior material as mentioned above can be materialized by adopting such steps.

Note that a structure of a base material for an automobile interior material in an embodiment of the present invention can be made as follows.

First, lamination of thermoplastic resin sheet layers is carried out taking rigidity improvement into consideration as mentioned above. Therefore, if a fibrous layer obtained through up to a heat adhering step has satisfactory rigidity, lamination of the thermoplastic resin sheet layer can be omitted.

An adhesive layer interposed between a fibrous layer and a thermoplastic resin sheet layer to form a base material for an automobile interior material in a laminated structure may be a breathing nonwoven fabric or a film that becomes non-breathing after heat adhering like a hot-melt film. Delamination of the base material for the interior material can be effectively avoided when the hot-melt film is used. In addition, a disadvantageous effect on a temperature change in a vehicle or air convection caused by running or the like can be reduced by means of a non-breathing layer. For instance, in a case of a headliner material as one example of materials for the interior material using the base material for the interior material according to the embodiment, such a disadvantageous effect can be suppressed that fine particles and the like go through interlayer direction of the base material for the interior material along the flow of air convection causing a sort of filtration phenomenon.

Moreover, in the thermoplastic resin sheet layer, an adhesive layer may be provided on the opposite side to a fibrous layer adhering side and a non-breathing film may be adhered thereto. The disadvantageous effect on the temperature change in the vehicle or the air convection caused by the running or the like can be reduced by means of such non-breathing layer on the base material for the interior material, as in the case of using the hot-melt film.

In a case where such adhesive layer is added, an apparatus or a method that adheres and laminates each interlayer may be arranged in accordance with a design of a desired base material for the interior material. Specifically, a heated air circulating furnace, a heating roll and the like similar to the above-mentioned can be optionally and preferably selected to use.

### EXAMPLES

Hereinafter, structures according to the examples of the present invention will be described together with assessment results. Note that the present examples will be exemplified with reference to specified conditions such as specified sizes, shapes, arrangements, numerical conditions and the like so as to facilitate understanding of the present invention. However, the present invention is not limited to the illustrated examples only, but optional and preferable modifications or alterations can be made within an object of the present invention.

### Example 1

(1) A Fibrous Layer Forming

As the base-material constituting fiber, following two kinds of fibers were prepared, which were heat adhesive staple fiber and hollow staple fiber having crimpable potential.

[Heat Adhesive Staple Fiber]

Material: polyester resin of a sheath-core (sheath component: polybutylene terephthalate modified by isophthalic acid [softening point: 110° C., melting point: 160° C.], core component: polyethylene terephthalate [softening point: 237° C. to 238° C., melting point: 240° C.])

Fineness: 4.4 dtex (fiber diameter: 20 μm)

Fiber length: 38 mm

[Hollow Staple Fiber Having Crimpable Potential]

Material: Toray tetron T-70 [made by Toray Industries, Inc.] (composite fiber of different intrinsic viscosity: polyethylene terephthalate/polyethylene terephthalate)

Fineness: 14.3 dtex (fiber diameter: 45 μm)

Fiber length: 51 mm

After the heat adhesive staple fiber 70% by mass and the hollow staple fiber having crimpable potential 30% by mass were blended, a fibrous web (surface density: 600 g/m², thickness: 80 mm) in which base-material constituting fibers were oriented in a thickness direction, was formed by the above-mentioned web forming apparatus including the carding machine. Next, a needle punching process (needle density: 50 needles/cm²) was performed for each side of the fibrous web to entangle the base-material constituting fibers mutually. Thereafter, the fibrous web was sent to a heated air circulating furnace where a heated air temperature was set to 175° C., and only a sheath component in the heat adhesive staple fiber of a polyester sheath-core was deposited without being pressurized, and also crimps were developed in the hollow staple fiber having crimpable potential whereby a crimped hollow staple fiber was formed. Thus, a fibrous layer (surface density: 600 g/m², thickness: 10 mm) for Example 1 is obtained.

(2) Preparation of a base material for the interior material As a thermoplastic resin sheet layer, a spunbonded nonwoven fabric (surface density: 70 g/m², thickness: 0.3 mm, with breathing performance) composed of 80% by mass of a polyethylene terephthalate filament (melting point: 240° C., softening point: 237° C. to 238° C.) and 20% by mass of a polyethylene terephthalate filament with a low melting point (melting point: 195° C., softening point: 150° C.) was prepared. In addition, as for an adhesive layer, a resin nonwoven fabric with a low melting point (surface density: 24 g/m², thickness: 0.2 mm with breathing performance) including polyester with a low melting point (melting point: 120° C.) was prepared. Next, the thermoplastic resin sheet layer and the adhesive layer were pressurized by heating with a heating roll at a temperature of 150° C., thus being integrated in advance as a compound nonwoven fabric.

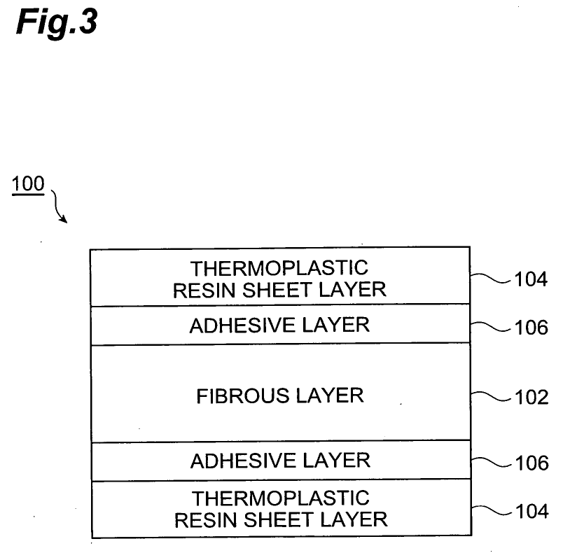

Subsequently, fibrous layer and compound nonwoven fabric were laminated as shown in FIG. 3 in the following order: a spunbonded nonwoven fabric 104 (thermoplastic resin sheet layer), a resin nonwoven fabric with a low melting point 106 (adhesive layer), a fibrous layer 102, a resin nonwoven fabric with the low melting point 106 (adhesive layer), and a spunbonded nonwoven fabric 104 (thermoplastic resin sheet layer), and thereafter the above-mentioned fibrous layer and the compound nonwoven fabric were heated again by a heated air circulating furnace where a heated air temperature was set to 230° C. As a result, the thickness was 10 mm. A base material for the interior material was taken out from the heated air circulating furnace after heating, and cold-pressed by a plate pressing machine. Each interlayer was thus pressure bonded and united through such steps, so that a base material for the interior 100 (surface density: 788 g/m², thickness: 8 mm) according to Example 1 was prepared.

### Example 2

(1) A Fibrous Layer Forming

The following fiber was prepared as one of base-material constituting fibers.

Material: Toray tetron T-201 [made by Toray Industries, Inc.] (a solid-core polyethylene terephthalate fiber with a circular section)

Fineness: 20 dtex (fiber diameter: 43 μm)

Fiber length: 64 mm

Softening point: 237° C. to 238° C.

Melting point: 240° C.

A fibrous web (surface density: 700 g/m², thickness: 80 mm) in which base-material constituting fibers were oriented in a thickness direction, was formed by the above-mentioned web forming apparatus including the carding machine, after the polyethylene terephthalate fiber 30% by mass and the heat adhesive staple fiber, used in Example 1, 70% by mass were blended. Next, a needle punching process (needle density: 50 needles/cm²) was performed on both sides of the fibrous web, and transferred to a heated air circulating furnace where a heated air temperature was set to 175° C., and deposited only a sheath component in the heat adhesive staple fiber of a polyester sheath-core without being pressurized. Herewith, a fibrous layer (surface density: 700 g/m², thickness: 10 mm) according to Example 2 was obtained.

(2) Preparation of a Base Material for the Interior

As for a thermoplastic resin sheet layer, a spunbonded nonwoven fabric (surface density: 20 g/m², thickness: 0.3 mm with breathing performance) composed of only a polyethylene terephthalate (melting point: 240° C., softening point: 237° C. to 238° C.) was prepared. In addition, as for an adhesive layer, a three-layer film composed of a modified olefin, nylon and the modified olefin (surface density: 50 g/m², thickness: 0.05 mm without breathing performance) was prepared. Next, the thermoplastic resin sheet layer and the adhesive layer were pressurized by heating with a heating roll where a temperature was set to 150° C., thus an integrated compound nonwoven fabric was obtained in advance.

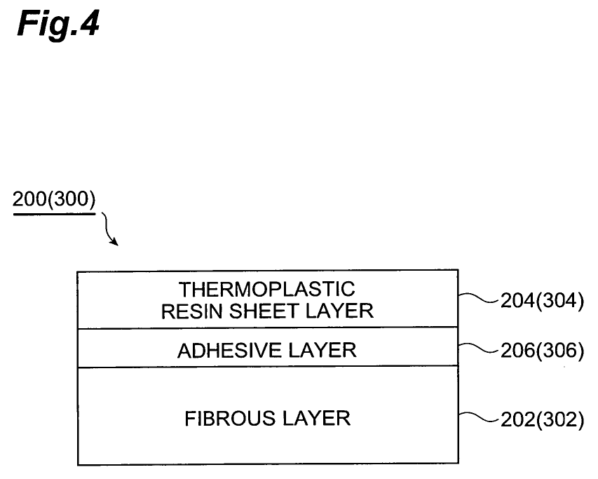

Subsequently, fibrous layer and compound nonwoven fabric were laminated as shown in FIG. 4 in the following order: a fibrous layer 202, a three-layer film 206 (adhesive layer) and a spunbonded nonwoven fabric 204 (thermoplastic resin sheet layer), and thereafter the above-mentioned fibrous layer and the compound nonwoven fabric were heated again by a heated air circulating furnace where a heated air temperature was set to 230° C. As a result, the thickness was 10 mm. A base material for the interior material was taken out from the heated air circulating furnace after heating, and cold-pressed by a plate pressing machine. Each interlayer was thus pressure bonded and united through such steps, so that a base material for the interior 200 (surface density: 770 g/m², thickness: 8 mm) according to Example 2 was prepared.

### Example 3

(1) A Fibrous Layer Forming

The following fiber was prepared as one of base-material constituting fibers.

Material: basalt fiber (artificial solid-core inorganic fiber whose major component is basalt)

Fiber diameter: 10 μm

Fiber length: 50 mm

Melting point: 1500° C.

A fibrous web (surface density: 700 g/m², thickness: 60 mm) in which base-material constituting fibers were oriented in a thickness direction, was formed by the above-mentioned web forming apparatus including the carding machine, after the basalt fiber 30% by mass and the heat adhesive staple fiber, used in Example 1, 70% by mass were blended. Next, a needle punching process (needle density: 50 needles/cm²) was performed on both sides of the fibrous web, and transferred to a heated air circulating furnace where a heated air temperature was set to 175° C., and deposited only a sheath component in the heat adhesive staple fiber of a polyester sheath-core without being pressurized. Herewith, a fibrous layer (surface density: 700 g/m², thickness: 10 mm) according to Example 3 was obtained.

(2) Preparation of a Base Material for the Interior

As for a thermoplastic resin sheet layer, a spunbonded nonwoven fabric (surface density: 20 g/m², thickness: 0.3 mm with breathing performance) composed of only a polyethylene terephthalate (melting point: 240° C., softening point: 237° C. to 238° C.) was prepared as in Example 2. In addition, as for an adhesive layer, a three-layer film composed of a modified olefin, nylon and the modified olefin (surface density: 50 g/m², thickness: 0.05 mm without breathing performance) was prepared. Next, the thermoplastic resin sheet layer and the adhesive layer were pressurized by heating with a heating roll where a temperature was set to 150° C., thus an integrated compound nonwoven fabric was obtained in advance.

Subsequently, fibrous layer and compound nonwoven fabric were laminated as shown in FIG. 4 in the following order: a fibrous layer 302, a three-layer film 306 (adhesive layer) and a spunbonded nonwoven fabric 304 (thermoplastic resin sheet layer), and thereafter the above-mentioned fibrous layer and the compound nonwoven fabric were heated again by a heated air circulating furnace where a heated air temperature was set to 230° C. As a result, the thickness was 10 mm. A base material for the interior material was taken out from the heated air circulating furnace after heating, and cold-pressed by a plate pressing machine. Each interlayer was thus pressure bonded and united through such steps, so that a base material for the interior 300 (surface density: 770 g/m², thickness: 8 mm) according to Example 3 was prepared.

### Comparative Example 1

(1) A Fibrous Layer Forming

A fibrous web (surface density: 600 g/m², thickness: 80 mm) was formed with the same fiber composition and web forming steps as Example 1 except that a needle punching process was not applied to the fibrous web. Next, the fibrous web was heated by a upper-lower band type heated air circulating furnace where a heated air temperature was set to 175° C. while upper and lower band gap was controlled to 10 mm. Herewith, a fibrous layer (surface density: 600 g/m², thickness: 10 mm) according to Comparative example 1 was obtained.

(2) Preparation of a Base Material for the Interior

After the fibrous layer was formed, the same compound nonwoven fabrics as Example 1, which was the one adhered by the thermoplastic resin sheet layer and an adhesive layer being pressurized by heating in advance, were used to be laminated so that the same laminated structure was obtained as the base materials for the interior 100 as show in FIG. 3 and heated again by the heated air circulating furnace where the heated air temperature was set to 230° C., and as a result, the thickness was 30 mm. The base materials for the interior were cold-pressed in the same way as Example 1 after heating. Each interlayer was pressure bonded and integrated through such steps, so that a base material for the interior (surface density: 788 g/m², thickness: 8 mm) according to Comparative example 1 was prepared.

### Comparative Example 2

(1) A Fibrous Layer Forming

A fibrous web (surface density: 600 g/m², thickness: 60 mm) was formed with the same fiber composition and a needle punching process condition as Example 1 except that a bidirectional fiber orientation (cloth lay) was provided in a principal surface direction of the fibrous web. Next, the fibrous web was processed with heat adhering without being pressurized by a heated air circulating furnace where a heated air temperature was set to 175° C. Herewith, a fibrous layer (surface density: 600 g/m², thickness: 10 mm) according to Comparative example 2 was obtained.

(2) Preparation of a Base Material for the Interior

After the fibrous layer was formed, each interlayer was pressure bonded and integrated through laminating compound nonwoven fabrics, re-heating in a heated air circulating furnace and cold-pressing in the same way as Example 1 and Comparative example 1, so that a base material for the interior (surface density: 788 g/m², thickness: 8 mm) according to Comparative example 2 was prepared.

### Comparative Example 3

(1) A Fibrous Layer Forming

A fibrous web (surface density: 600 g/m², thickness: 60 mm) was formed with the same condition as Comparative example 2 except that a needle punching process was not applied to the fibrous web. Next, the fibrous web was pressurized and adhered by a heating roll where the temperature was set to 175° C. Herewith, a fibrous layer (surface density: 600 g/m², thickness: 10 mm) according to Comparative example 3 was obtained.

(2) Preparation of a Base Material for the Interior

After the fibrous layer was formed, each interlayer was pressure bonded and integrated through laminating compound nonwoven fabrics, re-heating in a heated air circulating furnace and cold-pressing in the same way as Example 1, Comparative example 1 and Comparative example 2 so that a base material for the interior (surface density: 788 g/m², thickness: 8 mm) according to Comparative example 3 was obtained.

<Assessment Method of Shape Preserving Characteristics>

Next, shape preserving characteristics in a high temperature environment were assessed for a base material for the interior in the above-mentioned examples and comparative examples. First, rectangular specimens of 300 mm in a longitudinal direction (a flow direction in a manufacturing process of a fibrous layer) by 50 mm in a transverse direction were extracted from the above-mentioned each base material for the interior. One end portion of the rectangular specimen from the edge to 70 mm in the longitudinal direction was fixed on a rectangular parallelepiped stand, and the rest portion of 230 mm was protruded from the stand. Subsequently, the specimen was left in a constant temperature chamber where the temperature was set to 90° C. for 4 hours while the state of the specimens was maintained, and then the amount of hanging down at the tip of protruded portion from the stand was measured (unit: mm). If the hanging amount is less than 10 mm, shape preserving characteristics can be assessed as excellent.

<Method for Assessment of the Rigidity>

Additionally, as an assessment of the rigidity in an ordinary temperature, the rigidity measurement in 25° C. of a room temperature was carried out. First, rectangular specimens of 150 mm in a longitudinal direction by 50 mm in a transverse direction were extracted from each base material for the interior. The rectangular specimens were set like straddling on two supports, which were placed at intervals of 100 mm. Then, a central part between the two supports (a part of 50 mm from the support) was pressurized in a weight direction by a pressure wedge at 20 mm/min of a pressurizing speed. Pressurizing loads were measured in time-lapse manner by a tension tester having the wedge “TENSILON UCT-500” (made by ORIENTEC Co., LTD), so that the maximum point of the load was recorded.

Surface density, thickness and an assessment result of each sample of the base material for the interior are shown in Table 1.

TABLE 1

| | Surface | | Amount of | Maximum point of |
|---|---|---|---|---|
| | density | Thickness | hanging | load |
| | (g/m²) | (mm) | down (mm) | (N/50 mm) |
| Example 1 | 788 | 8 | 7 | 15 |
| Example 2 | 770 | 8 | 7 | 9 |
| Example 3 | 770 | 8 | 5 | 13 |
| Comparative | 788 | 8 | 11 | 12 |
| example 1 | | | | |
| Comparative | 788 | 8 | 11 | 10 |
| example 2 | | | | |
| Comparative | 788 | 8 | 12 | 10 |
| example 3 | | | | |

As appreciated from Table 1, Examples from 1 to 3 according to the embodiment of the present invention were excellent in the shape preserving characteristics corresponding to the amount of the hanging down, compared with any comparative examples.

First, as for an effect caused by entanglement of base-material constituting fibers that form a fibrous layer, it was confirmed from the comparison between Example 1 and Comparative example 1 that Example 1 with a needle punching process had excellent characteristics in both the shape preserving characteristics and the rigidity, compared with the comparative example 1 without the needle punching process. It is assumed that the base-material constituting fibers oriented in a thickness direction of a fibrous web are mutually entangled by the needle punching process whereby a fiber bundle is formed. Herewith, it is understood that each characteristic is improved.

Moreover, as for an effect caused by fiber orientation that forms a fibrous layer, it was confirmed, from the comparison between Example 1 and the Comparative example 2, that Example 1 that base-material constituting fibers were oriented in a thickness direction of a fibrous web had excellent characteristics in both the shape preserving characteristics and the rigidity, compared with Comparative Example 1 that had bi-directional fiber orientation (cloth lay) in a principal surface direction of the fibrous web.

Further, as for a laminated structure of a base material for the interior, excellent shape preserving characteristics could be achieved in Example 2 and 3 similar to Example 1 even though a thermoplastic resin sheet layer or the like was arranged only on one surface side of a fibrous layer allowing lighter designing, in comparison with Example 1 and Comparative examples 1 to 3. Besides, from the comparison between Example 2 and 3, excellent effects in both the amount of the hanging down and the maximum point of the load were achieved in Example 3 by adoption of inorganic fibers which were excellent in single fiber rigidity as a base-material constituting fiber that forms the fibrous layer.

As stated so far, a base material for an automobile interior material of the present invention is continuously accumulated in a direction orthogonal to a thickness direction in a state that base-material constituting fibers are oriented in the thickness direction. Therefore, the base-material constituting fibers can be oriented in the thickness direction without folding of a fibrous web. In addition, an interface that is generated when the fibrous web is folded can be virtually prevented since the fibrous web is not folded, according to the present invention. Further, since the base-material constituting fibers oriented in the thickness direction of the fibrous web are mutually entangled, the base material for the automobile interior material having excellent rigidity and shape preserving characteristics in a high temperature environment can be obtained.

Furthermore, adoption of a manufacturing method of the present invention can provide base material for the automobile interior material having above-mentioned structure.

The base material for the automobile interior material of the present invention can be used for a headliner material, a rear package tray material, a door trim material, a floor insulator material, a trunk trim material and a dash insulator material or the like for an automobile. A base material for the interior having small shape variation particularly in high temperature environment is adhered to a designed skin material to be a laminated structure can provide a preferable automobile interior material.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A base material for an automobile interior material, comprising:
a fibrous layer including a fibrous web in which two or more kinds of base-material constituting fibers including a heat adhesive staple fiber are continuously accumulated in a direction orthogonal to a thickness direction of the fibrous web and mutually entangled in a state that the base-material constituting fibers are oriented in the thickness direction; and
a thermoplastic resin sheet layer laminated on at least one of principal surfaces of the fibrous layer.

2. The base material for an automobile interior material according to claim 1, wherein a softening point of the heat adhesive staple fiber is about 90° C. or more.

3. The base material for an automobile interior material according to claim 1, wherein the fibrous web includes the heat adhesive staple fiber and a crimped hollow staple fiber as the base-material constituting fibers.

4. The base material for an automobile interior material according to claim 1, wherein the thermoplastic resin sheet layer is a spunbonded nonwoven fabric including two kinds of filaments, and a difference of melting point between the filaments is about 30° C. or more.

5. The base material for an automobile interior material according to claim 1, wherein each of base-material constituting fibers is made of polyester resin.

6. A base material for an automobile interior material, comprising:
a fibrous layer in which a fibrous web is processed with needle punching after two or more kinds of base-material constituting fibers including a heat adhesive staple fiber are continuously accumulated in a direction orthogonal to a thickness direction of the fibrous web in a state that the base-material constituting fibers are oriented in the thickness direction by an air lay process; and
a thermoplastic resin sheet layer laminated on at least one of principal surfaces of the fibrous layer.

7. The base material for an automobile interior material according to claim 6, wherein a softening point of the heat adhesive staple fiber is about 90° C. or more.

8. The base material for an automobile interior material according to claim 6, wherein the fibrous web includes the heat adhesive staple fiber and a crimped hollow staple fiber as the base-material constituting fibers.

9. The base material for an automobile interior material according to claim 6, wherein the thermoplastic resin sheet layer is a spunbonded nonwoven fabric including two kinds of filaments, and a difference of melting point between the filaments is about 30° C. or more.

10. The base material for an automobile interior material according to claim 6, wherein each of base-material constituting fibers is made of polyester resin.

11. A manufacturing method of a base material for an automobile interior material, the manufacturing method comprising:
forming a fibrous web by continuously accumulating two or more kinds of base-material constituting fibers including a heat adhesive staple fiber in a direction orthogonal to a thickness direction of the fibrous web in a state that the base-material constituting fibers are oriented in the thickness direction;
mutually entangling the base-material constituting fibers of the fibrous web; and
adhering the heat adhesive staple fiber to the other base-material constituting fiber by heating the fibrous web in order to form a fibrous layer.

12. The manufacturing method according to claim 11, wherein the fibrous web includes the heat adhesive staple fiber and a hollow staple fiber having crimpable potential as the base-material constituting fibers.

13. The manufacturing method according to claim 11, further comprising:
laminating a thermoplastic resin sheet layer on at least one of principal surfaces of the fibrous layer.

14. A manufacturing method of a base material for an automobile interior material, the manufacturing method comprising:
forming a fibrous web by continuously accumulating two or more kinds of base-material constituting fibers including a heat adhesive staple fiber in a direction orthogonal to a thickness direction of the fibrous web in a state that the base-material constituting fibers are oriented in the thickness direction by an air lay process;
entangling the fibrous web by needle punching process; and
adhering the heat adhesive staple fiber to the other base-material constituting fiber by heating the fibrous web in order to form a fibrous layer.

15. The manufacturing method according to claim 14, wherein the fibrous web includes the heat adhesive staple fiber and a hollow staple fiber having crimpable potential as the base-material constituting fibers.

16. The manufacturing method according to claim 14, further comprising:
laminating a thermoplastic resin sheet layer on at least one of principal surfaces of the fibrous layer.
